(19) United States
(12) Patent Application Publication
(10) Pub. No.: US 2021/0326514 A1
(43) Pub. Date: Oct. 21, 2021

(54) METHOD FOR GENERATING INTERPRETATION TEXT, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Yanyan LI, Beijing (CN); Airong JIANG, Beijing (CN); Dejing DOU, Beijing (CN)

(21) Appl. No.: 17/365,704

(22) Filed: Jul. 1, 2021

(30) Foreign Application Priority Data
Dec. 24, 2020 (CN) CN202011555798.8

(51) Int. Cl. G06F 40/14; G06F 40/40; G06F 16/26

(52) U.S. Cl. CPC G06F 40/14; G06F 16/26; G06F 40/40

(57) ABSTRACT

A method for generating an interpretation text, an electronic device and a storage medium are provided, and relate to the technical field of artificial intelligence, natural language processing, big data and the like. The method includes: determining a target variable required for generating an interpretation text of a target chart, according to a text generation instruction; acquiring a first variable corresponding to the target variable from a node of at least one layer of a tree structure according to the target variable, wherein categories of variables in nodes of each layer of the tree structure are different, and a variable in one upper-layered node is at least associated with a variable in one lower-layered node; and generating an interpretation text of the target chart according to the first variable and the text generation instruction.

### CROSS-REFERENCE TO RELATED APPLICATION

This application claims priority to Chinese Patent Application No. 202011555798.8, filed on Dec. 24, 2020, which is hereby incorporated by reference in its entirety.

### TECHNICAL FIELD

The present disclosure relates to the technical field of data processing, and in particular to the technical fields of artificial intelligence, natural language processing, big data and the like.

### BACKGROUND

At present, the analysis report of the chart is usually written artificially based on the chart data.

### SUMMARY

The present disclosure provides a method and an apparatus for generating an interpretation text, an electronic device and a storage medium.

According to an aspect of the present disclosure, there is provided a method for generating an interpretation text, and the method includes:

determining a target variable required for generating an interpretation text of a target chart, according to a text generation instruction;

acquiring a first variable corresponding to the target variable from a node of at least one layer of a tree structure according to the target variable, wherein categories of variables in nodes of each layer of the tree structure are different, and a variable in one upper-layered node is at least associated with a variable in one lower-layered node; and

generating an interpretation text of the target chart according to the first variable and the text generation instruction.

According to another aspect of the present disclosure, there is provided an apparatus for generating an interpretation text, and the apparatus includes:

a determination module, configured for determining a target variable required for generating an interpretation text of a target chart, according to a text generation instruction;

a first acquisition module, configured for acquiring a first variable corresponding to the target variable from a node of at least one layer of a tree structure according to the target variable, wherein categories of variables in nodes of each layer of the tree structure are different, and a variable in one upper-layered node is at least associated with a variable in one lower-layered node; and

a generation module, configured for generating an interpretation text of the target chart according to the first variable and the text generation instruction.

According to yet another aspect of the present disclosure, an electronic device is provided, and the function of the electronic device can be realized by hardware, or by software that executes the response by hardware. The hardware or software includes one or more modules corresponding to the above-mentioned functions.

In a possible design, the structure of the electronic device includes a processor and a memory, the memory is configured of storing a program that supports the electronic device to execute the abovementioned method for generating the interpretation text, and the processor is configured for executing programs stored in the memory. The electronic device may also include a communication interface configured for communicating with other devices or a communication network.

According to still another aspect of the present disclosure, there is provided a non-transitory computer-readable storage medium being stored with computer instructions, and configured for storing computer software instructions used by the electronic device, including programs used for executing the abovementioned method for generating the interpretation text.

According to yet still another aspect of the present disclosure, there is provided a computer program product including a computer program that, when executed by a processor, implements the abovementioned method for generating the interpretation text.

It is to be understood that the contents in this section are not intended to identify the key or critical features of the embodiments of the present disclosure, and are not intended to limit the scope of the present disclosure. Other features of the present disclosure will become readily apparent from the following description.

### BRIEF DESCRIPTION OF THE DRAWINGS

The drawings are included to provide a better understanding of the present disclosure and are not to be construed as limiting the present disclosure. Wherein:

FIG. 1 is a schematic diagram showing the implementation flow of a method for generating interpretation text according to an embodiment of the present disclosure;

FIG. 2 is a schematic diagram showing the implementation flow of steps S20 and S21 in the method for generating interpretation text according to an embodiment of the present disclosure;

FIG. 3 is a schematic diagram showing the implementation flow of steps S30 and S31 of the method for generating interpretation text according to an embodiment of the present disclosure;

FIG. 4 is a schematic diagram showing the implementation flow of steps S40 and S41 of the method for generating interpretation text according to an embodiment of the present disclosure;

FIG. 5 is a schematic diagram showing a tree structure according to an embodiment of the present disclosure;

FIG. 6 is a schematic diagram showing a chart according to an embodiment of the present disclosure;

FIG. 7 is a schematic structural diagram showing a device of generating interpretation text according to an embodiment of the present disclosure; and

FIG. 8 is a block diagram showing an electronic device configured for implementing the method for generating interpretation text in an embodiment of the present disclosure.

### DETAILED DESCRIPTION

Exemplary embodiments of the present disclosure are described below with reference to the accompanying drawings, wherein the various details of the embodiments of the present disclosure are included to facilitate understanding and are to be considered as exemplary only. Accordingly, a person skilled in the art should appreciate that various changes and modifications can be made to the embodiments described herein without departing from the scope and spirit of the present disclosure. Also, descriptions of well-known functions and structures are omitted from the following description for clarity and conciseness.

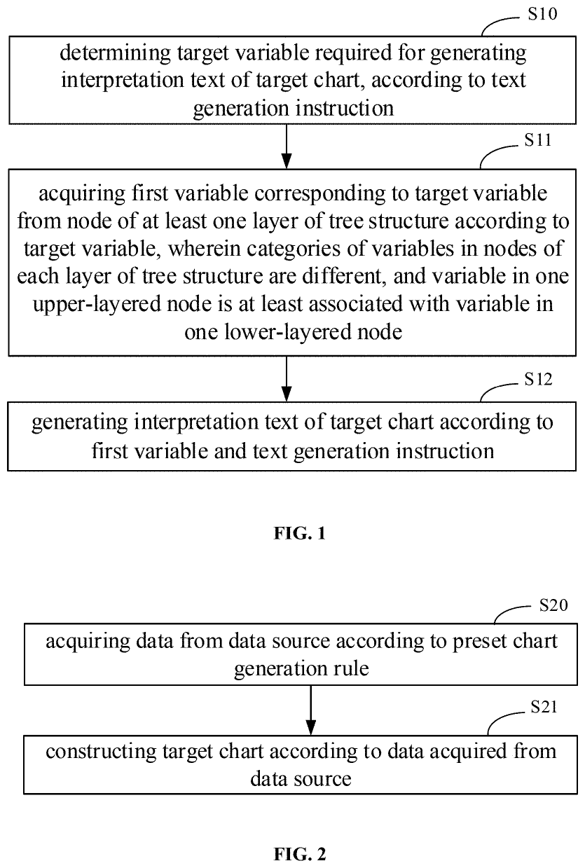

According to an embodiment of the present disclosure, as shown in FIG. 1, an embodiment of the present disclosure provides a method for generating an interpretation text, and the method includes the followings.

S10. Determining a target variable required for generating an interpretation text of a target chart, according to a text generation instruction.

The target chart can be understood as a chart for which interpretation text needs to be generated. The interpretation text can be understood as text analysis content generated based on the content shown in the target chart.

The target variable required for generating the interpretation text of the target chart may be one or multiple. The specific number of the target variables required is determined by the complexities of the text generation instruction and the generated interpretation text.

For example, when the text generation instruction is “total number of newly built hotels in Beijing in 2020”, the target variables may include “2020”, “Beijing”, “total number of newly built hotels”, and “total number of newly built hotels in Beijing in 2020”. Among them, “2020”, “Beijing”, and “total number of newly built hotels” can be understood as separate data variables, and “total number of newly built hotels in Beijing in 2020” can be understood as a combined variable formed by combination.

For another example, when the text generation instruction is “growth rate of the total number of newly built hotels in Beijing in 2020 compared to the total number of newly built hotels in Beijing in 2019”, the target variables may include “2020”, “2019”, “Beijing”, “total number of newly built hotels”, “total number of newly built hotels in Beijing in 2020”, “total number of newly built hotels in Beijing in 2019”, “growth rate of the total number of newly built hotels in Beijing in 2020 compared to the total number of newly built hotels in Beijing in 2019”. Among them, “2020”, “2019”, “Beijing”, and “total number of newly built hotels” can be understood as separate data variables, and “total number of newly built hotels in Beijing in 2020” and “total number of newly built hotels in Beijing in 2019” can be understood as a combined variable formed by combination, “growth rate of the total number of newly built hotels in Beijing in 2020 compared to the total number of newly built hotels in Beijing in 2019” can be understood as an operational variable.

S11. Acquiring a first variable corresponding to the target variable from a node of at least one layer of a tree structure according to the target variable. Wherein, categories of variables in nodes of each layer of the tree structure are different, and a variable in one upper-layered node is at least associated with a variable in one lower-layered node.

Width, depth, level of the tree structure, and path between the nodes of each layer are pre-built based on historical data. At least one variable is stored in each node of the tree structure.

Categories of the variables in the nodes of each layer are different, which can be understood as different definitions and different dimensions of the variables in the nodes of each layer. For example, the nodes of a first layer can use a single data as the variable. The nodes of a second layer can use a combination relationship of each single data as the variable.

The first variable corresponding to the target variable may be one or multiple.

For example, when the target variable is “total number of newly built hotels in Beijing in 2020”, and the variable in one of the nodes in the tree structure happens to be “total number of newly built hotels in Beijing in 2020”, the first variable corresponding to the target variable is one. According to the path relationship between the first variable and the lower-layered node (i.e., “2020”, “Beijing”, “total number of newly built hotels”), the data of the first variable, which is a value of the total number of newly built hotels in Beijing in 2020, can be obtained.

In another example, the target variable is “the growth rate of the total number of newly built hotels in Beijing in 2020 compared to the total number of newly built hotels in Beijing in 2019”, and the variable in one of the nodes in the tree structure is “the total number of newly built hotels in Beijing in 2020”, The variable in the other node is “Total number of newly built hotels in Beijing in 2019”, and there are two first variables corresponding to the target variable. According to the path relationship between the two first variables and the lower-layered node, the data of the two first variables can be obtained, and the total number of newly-built hotels in Beijing in 2020 and the total number of newly-built hotels in Beijing in 2019 can be obtained.

S12. Generating an interpretation text of the target chart according to the first variable and the text generation instruction.

The text generation instruction may contain text information required for generating the interpretation text.

The interpretation text can be generated based on one target chart, or it can be generated based on multiple target charts. That is to say, the solution of the embodiments of the present disclosure can realize the picture-viewing analysis of a chart, and also realize the picture-viewing analysis of synthesis of multiple charts.

Embodiments of the present disclosure can quickly and accurately generate the interpretation text of the chart by reusing the stored variables in the tree structure. There is no need to recalculate according to the same text generation instruction of different users. Achieved a routine and automated generation of the interpretation text of the chart. Cities are the carriers of human life. With the development of big data and artificial intelligence, quantitative analysis of cities has become an important component of smart cities. Urban quantitative analysis can evaluate all aspects of the city's roads, humanities, housing, education, etc. through big data, which assists city managers in making decisions. Therefore, batch, large-scale, automated, and routine generation of intelligent reports for cities or regions is very important. The method according to the embodiments of the present disclosure can reuse the interpretation text of the efficient and automated production chart based on the variables of the tree structure, and realize picture-viewing analysis of the big data-based chart. It has important value in smart cities, city rankings, and city assessments.

In an embodiment, as shown in FIG. 2, the method for generating interpretation text in this embodiment includes the above steps S10 to S12, wherein the method further includes S20 and S21, prior to the step S10 of determining the target variable required for generating the interpretation text of the target chart, according to the text generation instruction.

S20. Acquiring data from a data source according to a preset chart generation rule.

S21. Constructing a target chart according to the data acquired from the data source.

In this embodiment, it is possible to realize automatic collection and generation of charts based on data in the data source.

In an example, constructing a target chart set includes the followings.

Acquiring data from a data source according to a preset chart generation rule.

Constructing a plurality of target charts according to the data acquired from the data source.

Integrating the plurality of target charts to form a target chart set.

When the interpretation text needs to be generated, the required charts can be quickly acquired from the target chart set. Each target chart can contain a primary key (key), which is composed of (region_id, region_level, date). Among them, region_id represents regional identity information, such as Beijing is 110000; region_level represents regional level, such as 1, 2, 3, 4 respectively represent province, city, district, town; date represents data version, such as daily data, monthly data, quarterly data and annual data. A unique target chart can be determined based on the primary key (key).

In an example, as shown in FIG. 6, the target chart may be presented in the form of a histogram. Based on the target chart in FIG. 6, an interpretation text “Beijing has food quantity of 30,000 in January 2020, food quantity of 33,000 in February 2020, and a 10% increase in the food quantity in February compared to January” can be generated.

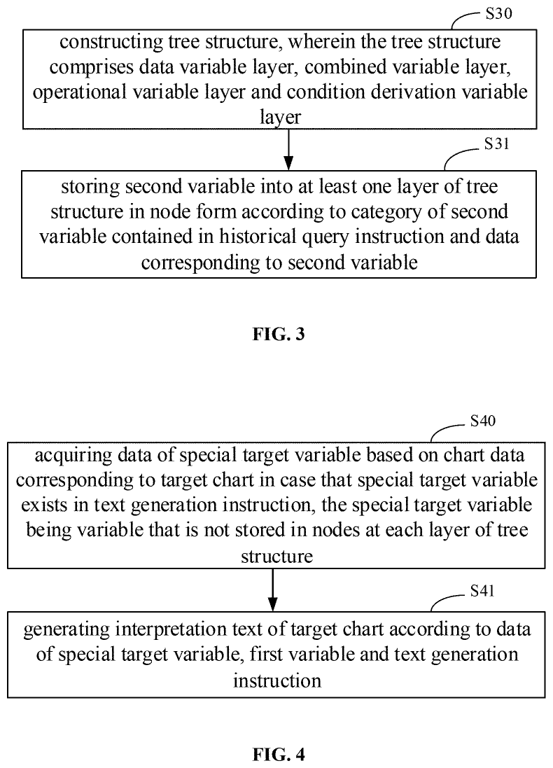

In an embodiment, as shown in FIG. 3, the method for generating interpretation text in this embodiment includes the above steps S10 to S12, wherein the method further includes S30 and S31, prior to the step S11 of acquiring a first variable corresponding to the target variable from a node of at least one layer of a tree structure according to the target variable.

S30. Constructing the tree structure, wherein the tree structure includes a data variable layer, a combined variable layer, an operational variable layer and a condition derivation variable layer; each node of the data variable layer is configured for storing a variable at a data level, each node of the combined variable layer is configured for storing a combined relation variable of each node of the data variable layer, each node of the operational variable layer is configured for storing an operational logic variable of each node of the combined variable layer, and each node of the condition derivation variable layer is configured for storing a logic judgment variable of each node of the combined variable layer and/or a logic judgment variable of each node of the operational variable layer.

Each node of the data variable layer may store variables input by the user, for example, region name, start time, end time, specific data, and so on. In an example, “Beijing”, “food quantity”, and “30000” can all be considered as variables stored in each node of the data variable layer.

Each node of the combined variable layer can store variables that are queried through conditional combinations. For example, the number of educational institutions in Beijing in 2019 corresponds to execution of the statement sql (Structured Query Language) for computers. The variable is obtained by selecting three variables (the number of educational institutions, Beijing, and 2019) from the data variable layer.

The operational variable layer is the basic operation of the combined variable layer. The operational variable layer is calculated based on the lower-level variables during the computer processing. For example, a year-on-year change rate of the number of educational institutions in Beijing in 2020 compared to 2019=the number of educational institutions in Beijing in 2020/the number of educational institutions in Beijing in 2019. Among them, the “year-on-year change rate of the number of educational institutions in Beijing in 2020 compared to 2019” is the variable of certain node of the operational variable layer, “the number of educational institutions in Beijing in 2020” and “the number of educational institutions in Beijing in 2019” are variables of certain nodes of the combined variable layer, “Beijing”, “2020”, “2019”, and “the number of educational institutions” are the variables of certain nodes of the data variable layer.

The condition derivation variable layer is a logical operation variable, which is a variable assignment through logical operation. It is a logical judgment statement for computers, such as “total population in Beijing in 2020 has increased or decreased compared to total population in Beijing in 2019” is the variable of a certain node of the condition derivation variable layer. “total population in Beijing in 2020” and “total population in Beijing in 2019” are the variables of certain nodes of the combined variable layer, and “Beijing”, “2020”, “2019” and “total population” are the variables of certain nodes of the data variable layer.

S31. Storing a second variable into at least one layer of the tree structure in a node form according to category of the second variable contained in a historical query instruction and data corresponding to the second variable.

The historical query instruction can be understood as an instruction input by a user in order to generate an interpretation chart.

In this embodiment, by storing the variables in the historical query instruction in the tree structure, reuse of the variables can be realized. When other users need to generate the same or similar interpretation text based on the chart, they can use the tree structure to directly obtain the existing variables, which saves the data traversal and calculation time required for generating the interpretation text.

In an example, the historical query instruction is “whether total population in Beijing in 2020 has increased or decreased compared to total population in Beijing in 2019”, then “whether total population in Beijing in 2020 has increased or decreased compared to the total population in Beijing in 2019” is used as a variable of the category of the condition derivation variable layer and stored as a variable of one node of the condition derivation variable layer. “Total population in Beijing in 2020” and “total population in Beijing in 2019” are variables of the category of the combined variable layer and stored as variables of the two nodes of the combined variable layer. “Beijing”, “2020”, “2019”, and “total population” is used as variables of the category of the data variable layer and stored as variables of one or more nodes of the data variable layer.

In an example, when the user constructs a description text, four categories of variables can be arbitrarily combined and defined. By constructing the variable tree structure, the calculation process of the variables can be reused as much as possible. For example, in a case that the two variables “the number of educational institutions in Beijing in 2019” (variable 1) and “the number of educational institutions in Beijing in 2020” (variable 2) are the variables stored by the two nodes of the combined variable layer, when the user needs to generate interpretation text related to variable 1 and variable 2, these two variables can be reused directly from the tree structure, and the variables and data can be quickly read from the data variable layer according to the pre-stored path of these two variables, without doing re-traverse and calculate.

In an embodiment, as shown in FIG. 4, the method for generating interpretation text in this embodiment includes the above steps S10 to S12, and further includes the followings.

S40. Acquiring data of a special target variable based on chart data corresponding to the target chart in a case that the special target variable exists in the text generation instruction. Here, the special target variable is a variable that is not stored in the nodes of each layer of the tree structure.

Step S12 of generating the interpretation text of the target chart according to the first variable and the text generation instruction, may further include the following step.

S41. Generating the interpretation text of the target chart according to the data of the special target variable, the first variable and the text generation instruction.

In this embodiment, through the reuse of variables in the tree structure and the data stored in the target chart, the interpretation text of the target chart can be quickly and accurately generated.

In an example, when the user needs to generate an interpretation text about “whether the total food quantity in Beijing in 2020 has increased or decreased compared to the total food quantity in Beijing in 2019”, the generating the interpretation text of the target chart according to the data of the special target variable, the first variable and the text generation instruction, includes the followings.

Acquiring data of the variable “total food quantity in 2019” that can be reused from the tree structure.

Acquiring that “total food quantity in Beijing in 2020 is XX, total food quantity in Beijing in 2019 is XX, and the total food quantity in 2020 has increased/decreased compared to 2019” as literal frame of the interpretation text according to the text generation instruction.

Acquiring data on the total food quantity in Beijing in 2020 according to the chart data of the target chart.

Generating the interpretation text that “total food quantity in Beijing in 2020 is 30,000, total food quantity in Beijing in 2019 is 29,000, and the total food quantity in 2020 has increased compared to 2019” based on the literal frame according to the “Total Food Quantity in 2019” data acquired from the tree structure and the “Total Food Quantity in 2020” data acquired from the target chart.

In an embodiment, the method for generating interpretation text in this embodiment includes the above steps S10 to S12, S40 and S41, and may further include the following step.

Storing the special target variable into at least one layer of the tree structure in a node form according to a category of the special target variable and the data of the special target variable.

In this embodiment, by storing the special target variable in the tree structure, it can be used as an existing variable and used as a reusable variable in subsequent generations of other interpretation text.

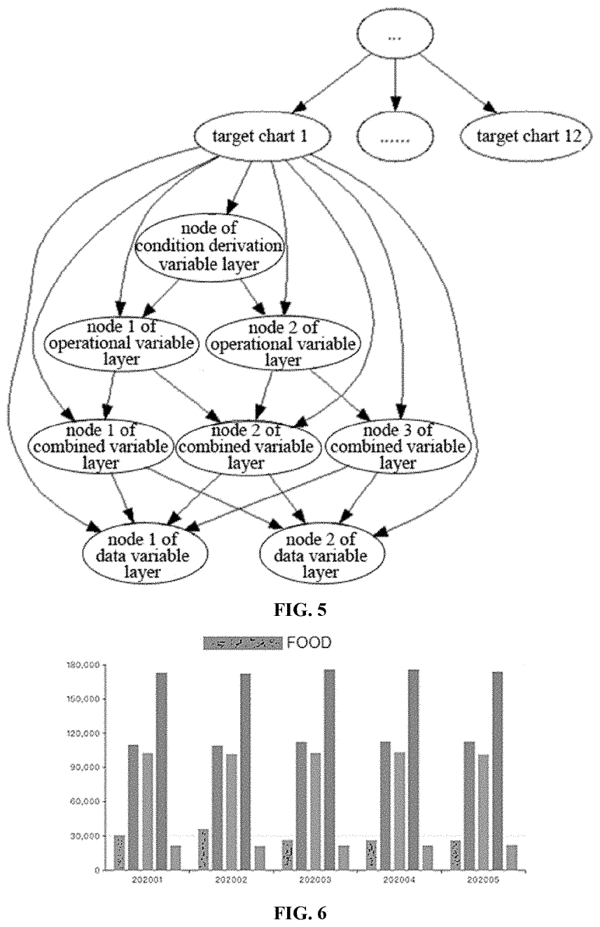

In an example, as shown in FIG. 5, a tree structure is constructed based on the historical query instruction of target chart 1. The tree structure includes the data variable layer, the combined variable layer, the operational variable layer and the condition derivation variable layer. The data variable layer includes node 1 of the data variable layer and node 2 of the data variable layer. The combined variable layer includes node 1 of the combined variable layer, node 2 of the combined variable layer, and node 3 of the combined variable layer. The operational variable layer includes node 1 of the operational variable layer and node 2 of the operational variable layer. The condition derivation variable layer includes a node of the condition derivation variable layer. When generating interpretation text related to target chart 1, the variables of the nodes in the data variable layer, the combined variable layer, the operational variable layer, and the condition derivation variable layer can be directly reused and the paths between the nodes of each layer can be reused, thereby existing variables required for rapid generation of the interpretation text are reused. It reduces the time required to generate interpretation text.

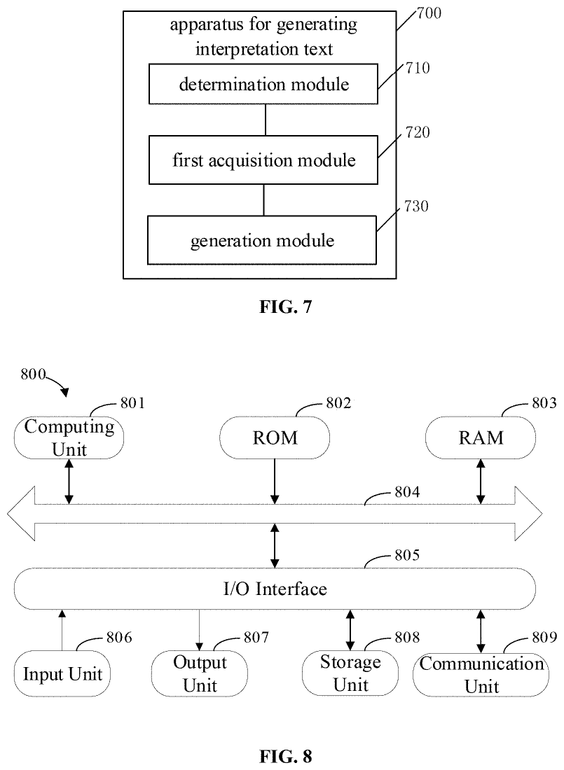

According to an embodiment of the present disclosure, as shown in FIG. 7, a device 700 of generating interpretation text is provided, including:

a determination module 710, configured for determining a target variable required for generating an interpretation text of a target chart, according to a text generation instruction;

a first acquisition module 720, configured for acquiring a first variable corresponding to the target variable from a node of at least one layer of a tree structure according to the target variable, wherein categories of variables in nodes of each layer of the tree structure are different, and a variable in one upper-layered node is at least associated with a variable in one lower-layered node; and

a generation module 730, configured for generating an interpretation text of the target chart according to the first variable and the text generation instruction.

In an embodiment, the device 700 of generating interpretation text further includes:

a second acquisition module, configured for acquiring data from a data source according to a preset chart generation rule; and

a construction module, configured for constructing the target chart according to the data acquired from the data source.

In an embodiment, the device 700 of generating interpretation text further includes:

a construction module, configured for constructing the tree structure, wherein the tree structure includes a data variable layer, a combined variable layer, an operational variable layer and a condition derivation variable layer; each node of the data variable layer is configured for storing a variable at a data level, each node of the combined variable layer is configured for storing a combined relation variable of each node of the data variable layer, each node of the operational variable layer is configured for storing an operational logic variable of each node of the combined variable layer, and each node of the condition derivation variable layer is configured for storing a logic judgment variable of each node of the combined variable layer and/or a logic judgment variable of each node of the operational variable layer; and

a first storage module, configured for storing a second variable into at least one layer of the tree structure in a node form according to category of the second variable contained in a historical query instruction and data corresponding to the second variable.

In an embodiment, the device 700 of generating interpretation text further includes:

a third acquisition module, configured for acquiring data of a special target variable based on chart data corresponding to the target chart, in a case that the special target variable exists in the text generation instruction. Wherein, the special target variable is a variable that is not stored in the nodes of each layer of the tree structure.

The generation module includes:

a generation sub-module, configured for generating the interpretation text of the target chart according to the data of the special target variable, the first variable and the text generation instruction.

In an embodiment, the device 700 of generating interpretation text further includes:

a second storage module, configured for storing the special target variable into at least one layer of the tree structure in a node form according to a category of the special target variable and the data of the special target variable.

For the functions of the apparatus for generating interpretation text, reference may be made to the various embodiments of the method for generating interpretation text, which will not be repeated here.

According to the embodiments of the present disclosure, the present disclosure also provides an electronic device, a readable storage medium, and a computer program product.

FIG. 8 is a schematic block diagram showing an electronic device 800 that may be configured for implementing the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular telephones, smart phones, wearable devices, and other similar computing devices. The components shown herein, their connections and relationships, and their functions are by way of example only and are not intended to limit the implementations of the present disclosure described and/or claimed herein.

As shown in FIG. 8, the electronic device 800 includes a computing unit 801, which can perform various appropriate actions and processing based on a computer program stored in a Read-Only Memory (ROM) 802 or a computer program loaded from the storage unit 808 into a Random Access Memory (RAM) 803. In the RAM 803, various programs and data required for the operation of the electronic device 800 can also be stored. The calculation unit 801, the ROM 802, and the RAM 803 are connected to each other through a bus 804. An input/output (I/O) interface 805 is also connected to the bus 804.

A plurality of components in the electronic device 800 are connected to the I/O interface 805, including: an input unit 806, such as keyboard, mouse, etc.; an output unit 807, such as various types of displays, speakers, etc.; and a storage unit 808, such as disk, optical disc, etc.; and a communication unit 809, such as network card, modem, wireless communication transceiver, etc. The communication unit 809 allows the electronic device 800 to exchange information/data with other devices through a computer network such as Internet and/or various telecommunication networks.

The computing unit 801 may be various general-purpose and/or special-purpose processing components with processing and computing capabilities. Some examples of the computing unit 801 include but are not limited to Central Processing Unit (CPU), Graphics Processing Unit (GPU), various dedicated Artificial Intelligence (AI) computing chips, various computing units running machine learning model algorithms, Digital Signal Processing (DSP), and any appropriate processor, controller, microcontroller, etc. The calculation unit 801 executes the various methods and processes described above, such as the method for generating interpretation text. For example, in some embodiments, the method for generating interpretation text may be implemented as a computer software program, which is tangibly contained in a machine-readable medium, such as the storage unit 808. In some embodiments, part or all of the computer programs may be loaded and/or installed on the electronic device 800 via the ROM 802 and/or the communication unit 809. When the computer program is loaded into the RAM 803 and executed by the calculation unit 801, one or more steps of the method for generating interpretation text described above can be executed. Alternatively, in other embodiments, the calculation unit 801 may be configured to perform the method for generating interpretation text through any other suitable means (for example, by means of firmware).

Various implementations of the systems and technologies described herein above can be implemented in digital electronic circuit systems, integrated circuit systems, Field Programmable Gate Arrays (FPGA), Application Specific Integrated Circuits (ASIC), Application-Specific Standard Products (ASSP), System On Chip (SOC), Complex Programmable Logic Device (CPLD), computer hardware, firmware, software, and/or combination(s) thereof. These implementations may include: being implemented in one or more computer programs which can be executed and/or interpreted on a programmable system including at least one programmable processor, the programmable processor can be a special-purpose or general-purpose programmable processor that can receive data and instructions from the storage system, at least one input device, and at least one output device, and transmit the data and instructions to the storage system, the at least one input device, and the at least one output device.

The program code used to implement the method provided by the present disclosure can be written in any combination(s) of one or more programming languages. These program codes can be provided to the processors or controllers of general-purpose computers, special-purpose computers, or other programmable data processing devices, so that the program codes, when executed by the processors or controllers, enable the functions/operations specified in the flowcharts and/or block diagrams to be implemented. The program code can be executed entirely on the machine, or partly executed on the machine, or partly executed on the machine and partly executed on a remote machine as an independent software package, or entirely executed on the remote machine or server.

In the context of the present disclosure, a machine-readable medium may be a tangible medium, which may contain or store a program for use by an instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination(s) of the foregoing. More specific examples of machine-readable storage medium would include electrical connections according to one or more wires, portable computer disks, hard disks, Random Access Memory (RAM), Read-Only Memory (ROM), Erasable Programmable Read-Only Memory (EPROM or flash memory), optical fibers, portable Compact Disk Read-Only Memory (CD-ROM), optical storage device, magnetic storage device, or any suitable combination of the foregoing.

To provide for interaction with a user, the systems and techniques described herein may be implemented on a computer having: a display apparatus (e.g., a Cathode Ray Tube (CRT) or Liquid Crystal Display (LCD) monitor) for displaying information to a user; and a keyboard and a pointing apparatus (e.g., a mouse or a trackball) by which a user can provide input to the computer. Other types of apparatuses may also be used to provide interaction with a user; for example, the feedback provided to the user may be any form of sensory feedback (e.g., visual feedback, audile feedback, or tactile feedback); and input from the user may be received in any form, including acoustic input, audio input, or tactile input.

The systems and techniques described herein may be implemented in a computing system that includes a background component (e.g., as a data server), or a computing system that includes a middleware component (e.g., an application server), or a computing system that includes a front-end component (e.g., a user computer having a graphical user interface or a web browser through which a user may interact with embodiments of the systems and techniques described herein), or in a computing system that includes any combination of such background component, middleware component, or front-end component. The components of the system may be interconnected by digital data communication (e.g., a communication network) of any form or medium. Examples of the communication networks include: Local Area Networks (LANs), Wide Area Networks (WANs), and Internet.

The computer system may include a client and a server. The client and the server are typically remote from each other and typically interact through a communication network. A relationship between the client and the server is generated by computer programs operating on respective computers and having a client-server relationship with each other. The server may be a cloud server, also known as a cloud computing server or cloud host, which is a host product in the cloud computing service system to solve the defects including difficult management and weak business scalability existed in traditional physical host and Virtual Private Server (VPS) services. The server can also be a server of a distributed system, or a server combined with a blockchain.

It will be appreciated that the various forms of flow, reordering, adding or removing steps shown above may be used. For example, the steps recited in the present disclosure may be performed in parallel or sequentially or may be performed in a different order, so long as the desired results of the technical solutions disclosed in the present disclosure can be achieved, and no limitation is made herein.

The above-mentioned embodiments are not to be construed as limiting the scope of the present disclosure. It will be apparent to a person skilled in the art that various modifications, combinations, sub-combinations and substitutions are possible, depending on design requirements and other factors. Any modifications, equivalents, and improvements within the spirit and principles of the present disclosure are intended to be included within the scope of the present disclosure.

What is claimed is:

1. A method for generating an interpretation text, comprising:
determining a target variable required for generating an interpretation text of a target chart, according to a text generation instruction;
acquiring a first variable corresponding to the target variable from a node of at least one layer of a tree structure according to the target variable, wherein categories of variables in nodes of each layer of the tree structure are different, and a variable in one upper-layered node is at least associated with a variable in one lower-layered node; and
generating the interpretation text of the target chart according to the first variable and the text generation instruction.

2. The method of claim 1, further comprising: prior to the determining the target variable required for generating the interpretation text of the target chart, according to the text generation instruction,
acquiring data from a data source according to a preset chart generation rule; and
constructing the target chart according to the data acquired from the data source.

3. The method of claim 1, further comprising: prior to the acquiring the first variable corresponding to the target variable from the node of at least one layer of the tree structure according to the target variable,
constructing the tree structure, wherein the tree structure comprises a data variable layer, a combined variable layer, an operational variable layer and a condition derivation variable layer; each node of the data variable layer is configured for storing a variable at a data level, each node of the combined variable layer is configured for storing a combined relation variable of each node of the data variable layer, each node of the operational variable layer is configured for storing an operational logic variable of each node of the combined variable layer, and each node of the condition derivation variable layer is configured for storing a logic judgment variable of each node of the combined variable layer and/or a logic judgment variable of each node of the operational variable layer; and
storing a second variable into at least one layer of the tree structure in a node form according to a category of the second variable contained in a historical query instruction and data corresponding to the second variable.

4. The method of claim 1, further comprising:
acquiring data of a special target variable based on chart data corresponding to the target chart in a case that the special target variable exists in the text generation instruction, wherein the special target variable is a variable that is not stored in the nodes of each layer of the tree structure; and
wherein the generating the interpretation text of the target chart according to the first variable and the text generation instruction, comprises:
generating the interpretation text of the target chart according to the data of the special target variable, the first variable and the text generation instruction.

5. The method of claim 2, further comprising:
acquiring data of a special target variable based on chart data corresponding to the target chart in a case that the special target variable exists in the text generation instruction, wherein the special target variable is a variable that is not stored in the nodes of each layer of the tree structure; and
wherein the generating the interpretation text of the target chart according to the first variable and the text generation instruction, comprises:
generating the interpretation text of the target chart according to the data of the special target variable, the first variable and the text generation instruction.

6. The method of claim 3, further comprising:
acquiring data of a special target variable based on chart data corresponding to the target chart in a case that the special target variable exists in the text generation instruction, wherein the special target variable is a variable that is not stored in the nodes of each layer of the tree structure; and
wherein the generating the interpretation text of the target chart according to the first variable and the text generation instruction, comprises:
generating the interpretation text of the target chart according to the data of the special target variable, the first variable and the text generation instruction.

7. The method of claim 4, further comprising:
storing the special target variable into at least one layer of the tree structure in a node form according to a category of the special target variable and the data of the special target variable.

8. The method of claim 5, further comprising:
storing the special target variable into at least one layer of the tree structure in a node form according to a category of the special target variable and the data of the special target variable.

9. The method of claim 6, further comprising:
storing the special target variable into at least one layer of the tree structure in a node form according to a category of the special target variable and the data of the special target variable.

10. An electronic device, comprising:
at least one processor; and
a memory communicatively coupled to the at least one processor;
wherein the memory is stored with instructions executable by the at least one processor to enable the at least one processor to:
determine a target variable required for generating an interpretation text of a target chart, according to a text generation instruction;
acquire a first variable corresponding to the target variable from a node of at least one layer of a tree structure according to the target variable, wherein categories of variables in nodes of each layer of the tree structure are different, and a variable in one upper-layered node is at least associated with a variable in one lower-layered node; and
generate the interpretation text of the target chart according to the first variable and the text generation instruction.

11. The electronic device of claim 10, wherein the instructions are executable by the at least one processor to enable the at least one processor further to: prior to the determining the target variable required for generating the interpretation text of the target chart, according to the text generation instruction,
acquire data from a data source according to a preset chart generation rule; and
construct the target chart according to the data acquired from the data source.

12. The electronic device of claim 10, wherein the instructions are executable by the at least one processor to enable the at least one processor further to: prior to the acquiring the first variable corresponding to the target variable from the node of at least one layer of the tree structure according to the target variable,
construct the tree structure, wherein the tree structure comprises a data variable layer, a combined variable layer, an operational variable layer and a condition derivation variable layer; each node of the data variable layer is configured for storing a variable at a data level, each node of the combined variable layer is configured for storing a combined relation variable of each node of the data variable layer, each node of the operational variable layer is configured for storing an operational logic variable of each node of the combined variable layer, and each node of the condition derivation variable layer is configured for storing a logic judgment variable of each node of the combined variable layer and/or a logic judgment variable of each node of the operational variable layer; and
store a second variable into at least one layer of the tree structure in a node form according to a category of the second variable contained in a historical query instruction and data corresponding to the second variable.

13. The electronic device of claim 10, wherein the instructions are executable by the at least one processor to enable the at least one processor further to:
acquire data of a special target variable based on chart data corresponding to the target chart in a case that the special target variable exists in the text generation instruction, wherein the special target variable is a variable that is not stored in the nodes of each layer of the tree structure; and
wherein the generating the interpretation text of the target chart according to the first variable and the text generation instruction, comprises:
generate the interpretation text of the target chart according to the data of the special target variable, the first variable and the text generation instruction.

14. The electronic device of claim 13, wherein the instructions are executable by the at least one processor to enable the at least one processor further to:
store the special target variable into at least one layer of the tree structure in a node form according to a category of the special target variable and the data of the special target variable.

15. A non-transitory computer-readable storage medium being stored with computer instructions for causing a computer to:
determine a target variable required for generating an interpretation text of a target chart, according to a text generation instruction;
acquire a first variable corresponding to the target variable from a node of at least one layer of a tree structure according to the target variable, wherein categories of variables in nodes of each layer of the tree structure are different, and a variable in one upper-layered node is at least associated with a variable in one lower-layered node; and
generate the interpretation text of the target chart according to the first variable and the text generation instruction.

16. The non-transitory computer-readable storage medium of claim 15, wherein the computer instructions are configured for causing the computer further to: prior to the determining the target variable required for generating the interpretation text of the target chart, according to the text generation instruction,
acquire data from a data source according to a preset chart generation rule; and
construct the target chart according to the data acquired from the data source.

17. The non-transitory computer-readable storage medium of claim 15, wherein the computer instructions are configured for causing the computer further to: prior to the acquiring the first variable corresponding to the target variable from the node of at least one layer of the tree structure according to the target variable,
construct the tree structure, wherein the tree structure comprises a data variable layer, a combined variable layer, an operational variable layer and a condition derivation variable layer; each node of the data variable layer is configured for storing a variable at a data level, each node of the combined variable layer is configured for storing a combined relation variable of each node of the data variable layer, each node of the operational variable layer is configured for storing an operational logic variable of each node of the combined variable layer, and each node of the condition derivation variable layer is configured for storing a logic judgment variable of each node of the combined variable layer and/or a logic judgment variable of each node of the operational variable layer; and
store a second variable into at least one layer of the tree structure in a node form according to a category of the second variable contained in a historical query instruction and data corresponding to the second variable.

18. The non-transitory computer-readable storage medium of claim 15, wherein the computer instructions are configured for causing the computer further to:
acquire data of a special target variable based on chart data corresponding to the target chart in a case that the special target variable exists in the text generation instruction, wherein the special target variable is a variable that is not stored in the nodes of each layer of the tree structure; and
wherein the generating the interpretation text of the target chart according to the first variable and the text generation instruction, comprises:
generate the interpretation text of the target chart according to the data of the special target variable, the first variable and the text generation instruction.

19. The non-transitory computer-readable storage medium of claim 16, wherein the computer instructions are configured for causing the computer further to:
acquire data of a special target variable based on chart data corresponding to the target chart in a case that the special target variable exists in the text generation instruction, wherein the special target variable is a variable that is not stored in the nodes of each layer of the tree structure; and
wherein the generating the interpretation text of the target chart according to the first variable and the text generation instruction, comprises:
generate the interpretation text of the target chart according to the data of the special target variable, the first variable and the text generation instruction.

20. The non-transitory computer-readable storage medium of claim 18, wherein the computer instructions are configured for causing the computer further to:
store the special target variable into at least one layer of the tree structure in a node form according to a category of the special target variable and the data of the special target variable.
